(19) United States
(12) Patent Application Publication
(10) Pub. No.: US 2025/0361172 A1
(43) Pub. Date: Nov. 27, 2025

(54) FUSION FORMABLE GLASS COMPOSITION AND COLORED GLASS-BASED ARTICLES FORMED THEREFROM

(71) Applicant: CORNING INCORPORATED, CORNING, NY (US)

(72) Inventors: Xiaoju Guo, Pittsford, NY (US); Lina Ma, Corning, NY (US)

(21) Appl. No.: 18/873,969

(22) PCT Filed: Jun. 15, 2023
(86) PCT No.: PCT/US2023/025375

§ 371 Date: Dec. 11, 2024

Related U.S. Application Data
(60) Provisional application No. 63/353,212, filed on Jun. 17, 2022.

(51) Int. Cl. C03C 3/085; C03C 4/02

(52) U.S. Cl. CPC C03C 3/085; C03C 4/02; C03C 2201/30

(57) ABSTRACT

A glass composition is provided including greater than or equal to 60 mol % to less than or equal to 75 mol % SiO₂; greater than or equal to 10 mol % to less than or equal to 20 mol % Al₂O₃; greater than or equal to 5 mol % to less than or equal to 20 mol % Li₂O; greater than or equal to 5 mol % to less than or equal to 15 mol % Na₂O; greater than 0 mol % to less than or equal to 1 mol % K₂O; greater than 0 mol % to less than or equal to 8 mol % MgO; and greater than or equal to 0.0001 mol % to less than or equal to 0.01 mol % Au. The glass composition may be fusion formed to produce a glass-based article. The glass-based article may be colored.

### CROSS-REFERENCE TO RELATED APPLICATIONS

This application claims the benefit of priority under 35 U.S.C. § 119 of U.S. Provisional Application Ser. No. 63/353,212 filed on Jun. 17, 2022, the content of which is relied upon and incorporated herein by reference in its entirety.

### FIELD

The present specification generally relates to glass compositions and glass articles and, in particular, to glass compositions that are fusion formable and ion-exchangeable, colored glass articles formed therefrom.

### TECHNICAL BACKGROUND

Aluminosilicate glass articles may exhibit superior ion-exchangeability and drop performance. Various industries, including the consumer electronics industry, desire colored materials with the same or similar strength and fracture toughness properties. However, simply including colorants in conventional aluminosilicate glass compositions may not produce the desired color.

Accordingly, a need exists for alternative colored glass articles having high strength and fracture toughness.

### SUMMARY

According to an aspect, a glass composition is provided. The glass composition comprises: greater than or equal to 60 mol % to less than or equal to 75 mol % SiO₂; greater than or equal to 10 mol % to less than or equal to 20 mol % Al₂O₃; greater than or equal to 5 mol % to less than or equal to 20 mol % Li₂O; greater than or equal to 5 mol % to less than or equal to 15 mol % Na₂O; greater than 0 mol % to less than or equal to 1 mol % K₂O; and greater than or equal to 0.0001 mol % to less than or equal to 0.01 mol % Au.

According to another aspect, a glass composition is provided. The glass composition comprises: greater than or equal to 60 mol % to less than or equal to 75 mol % SiO₂; greater than or equal to 10 mol % to less than or equal to 20 mol % Al₂O₃; greater than or equal to 5 mol % to less than or equal to 20 mol % Li₂O; greater than or equal to 2 mol % to less than or equal to 15 mol % Na₂O; greater than 0 mol % to less than or equal to 1 mol % K₂O; and greater than 0 mol % to less than or equal to 8 mol % MgO; and greater than or equal to 0.0001 mol % to less than or equal to 0.01 mol % Au.

According to another aspect, a glass-based article is provided. The glass-based article comprises the glass composition of a preceding aspect.

According to another aspect, a method of forming a glass-based article is provided. The method comprises fusion forming a glass composition to form a glass-based article, the glass composition comprising the glass composition of a preceding aspect.

Additional features and advantages of the colored glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute apart of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating any of the colored glass articles according to one or more embodiments described herein;

FIG. 2 is a perspective view of the electronic device of FIG. 1;

FIG. 3 is a photograph of colored glass articles according to embodiments; and

FIG. 4 is a photograph of colored glass articles with various compositions and heat treatments according to embodiments.

### DETAILED DESCRIPTION

Reference will now be made in detail to various embodiments of glass compositions and colored glass articles formed therefrom having a desired color. According to embodiments, a glass composition including greater than or equal to 60 mol % to less than or equal to 75 mol % SiO₂, greater than or equal to 10 mol % to less than or equal to 20 mol % Al₂O₃, greater than or equal to 5 mol % to less than or equal to 20 mol % Li₂O, greater than or equal to 5 mol % to less than or equal to 15 mol % Na₂O, greater than 0 mol % to less than or equal to 1 mol % K₂O, greater than 0 mol % to less than or equal to 8 mol % MgO, and greater than or equal to 0.0001 mol % to less than or equal to 0.01 mol % Au is provided. The glass composition is fusion formable.

In other embodiments, a glass composition including greater than or equal to 60 mol % to less than or equal to 75 mol % SiO₂, greater than or equal to 10 mol % to less than or equal to 20 mol % Al₂O₃, greater than or equal to 5 mol % to less than or equal to 20 mol % Li₂O, greater than or equal to 2 mol % to less than or equal to 15 mol % Na₂O, greater than 0 mol % to less than or equal to 1 mol % K₂O, greater than 0 mol % to less than or equal to 8 mol % MgO, and greater than or equal to 0.0001 mol % to less than or equal to 0.01 mol % Au is provided. The glass composition is fusion formable.

Various embodiments of colored glass articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and the resultant colored glass articles described herein, the concentrations of constituent components in oxide form (e.g., SiO₂, Al₂O₃, and the like) are specified in mole percent (mol %) on an oxide basis, unless otherwise specified.

In embodiments of the glass compositions and the resultant colored glass articles described herein, the concentration of Au, Ag, and Pt is specified in mole percent (mol %) or parts per million (ppm). “Mol %” refers to the concentration of respective atoms in the glass composition in any form. “Ppm” refers to the number of units of mass of the respective constituent component per million units of total mass of the glass composition.

Theterm “substantially free,” when used to describe the concentration and/or absence of a particular constituent component in a glass composition and the resultant colored glass article, means that the constituent component is not intentionally added to the glass composition and the resultant colored glass article. However, the glass composition and the resultant colored glass article may contain traces of the constituent component as a contaminant or tramp in amounts of less than 0.1 mol %.

The terms “0 mol %” and “free,” when used to describe the concentration and/or absence of a particular constituent component in a glass composition and the resultant colored glass article, means that the constituent component is not present in glass composition and the resultant colored glass article.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. Depth of compression (DOC) is also measured with the FSM. The maximum central tension (CT) values are measured using a scattered light polariscope (SCALP) technique known in the art.

The term “depth of compression” (DOC), as used herein, refers to the position in the article where compressive stress transitions to tensile stress.

The term “CIELAB color space,” as used herein, refers to a color space defined by the International Commission on Illumination (CIE) in 1976. It expresses color as three values: L* for the lightness from black (0) to white (100), a* from green (−) to red (+), and b* from blue (−) to yellow (+).

The term “color gamut,” as used herein, refers to the pallet of colors that may be achieved by the colored glass articles within the CIELAB color space.

Colorants may be added to aluminosilicate glass compositions to achieve a colored glass article having a desired color and improved mechanical properties. For example, gold (Au) doped glass-based articles of the type described herein may appear blue, purple, red, pink, and orange.

Disclosed herein are glass compositions and colored glass-based articles formed therefrom that allow the addition of Au to aluminosilicate glass compositions to produce colored glass-based articles having the desired color while being compatible with a fusion forming process. Specifically, the concentration of certain constituent components may be adjusted to achieve a desired color and to render the glass composition compatible with a fusion process.

The term “glass-based article” as utilized herein refers to an article made wholly or partially of glass, and may include glass, glass-ceramic, and glass laminate materials. For the sake of convenience, it should be understood that where a glass article is referred to herein a glass-based article is also disclosed.

The glass compositions and colored glass articles described herein may be described as alkali aluminosilicate glass compositions and colored glass-based articles and comprise SiO₂, Al₂O₃, Li₂O, Na₂O, and K₂O. In addition to SiO₂, Al₂O₃, Li₂O, Na₂O, and K₂O, the glass compositions and colored glass articles described herein include Auto produce colored glass articles having the desired color. The inclusion of alkali oxides, such as Li₂O, Na₂O, and K₂O, in the glass compositions enable the ion-exchangeability of the colored glass articles. Furthermore, the viscosity of the glass composition may be adjusted to enable compatibility with fusion forming processes and prevent devitrification of the glass composition and precipitation of Au particles during melting and forming that may limit the color gamut that may be achieved. Specifically, to be compatible with a fusion process, the glass compositions described herein may have a relatively low Li₂O concentration (e.g., less than or equal to 20 mol %), a relatively low MgO concentration (e.g., less than or equal to 8 mol %), and a relatively high Na₂O concentration (e.g., greater than or equal to 2 mol %) to achieve a desired liquidus viscosity (e.g., greater than or equal to 50 kP) and a desired liquidus temperature (e.g., less than or equal to 1300° C.).

SiO₂ is the primary glass former in the glass compositions described herein and may function to stabilize the network structure of the colored glass articles. The concentration of SiO₂ in the glass compositions and resultant colored glass articles should be sufficiently high to enhance the chemical durability of the glass composition and, in particular, the resistance of the glass composition to degradation upon exposure to acidic solutions, basic solutions, and in water. The amount of SiO₂ may be limited to control the melting point of the glass composition, as the melting point of pure SiO₂ or high SiO₂ glasses is undesirably high. Thus, limiting the concentration of SiO₂ may aid in improving the meltability and the formability of the resultant colored glass article.

In embodiments, the glass composition and the resultant colored glass article may comprise greater than or equal to 60 mol % and less than or equal to 75 mol % SiO₂, such as greater than or equal to 65 mol % and less than or equal to 72 mol % SiO₂. In embodiments, the concentration of SiO₂ in the glass composition and the resultant colored glass article may be greater than or equal to 60 mol %, greater than or equal to 62 mol %, greater than or equal to 64 mol %, greater than or equal to 66 mol %, greater than or equal to 68 mol %, greater than or equal to 70 mol %, greater than or equal to 72 mol %, greater than or equal to 74 mol %, or more. In embodiments, the concentration of SiO₂ in the glass composition and the colored resultant glass article may be less than or equal to 75 mol %, less than or equal to 73 mol %, less than or equal to 71 mol %, less than or equal to 69 mol %, less than or equal to 67 mol %, less than or equal to 65 mol %, less than or equal to 63 mol %, less than or equal to 61 mol %, or less. In embodiments, the concentration of SiO₂ in the glass composition and the resultant colored glass article may be greater than or equal to 60 mol % and less than or equal to 75 mol %, greater than or equal to 61 mol % and less than or equal to 74 mol %, greater than or equal to 62 mol % and less than or equal to 73 mol %, greater than or equal to 63 mol % and less than or equal to 72 mol %, greater than or equal to 64 mol % and less than or equal to 71 mol %, greater than or equal to 65 mol % and less than or equal to 70 mol %, greater than or equal to 66 mol % and less than or equal to 69 mol %, greater than or equal to 67 mol % and less than or equal to 68 mol %, or any and all sub-ranges formed from any of these endpoints.

Like SiO₂, Al₂O₃ may also stabilize the glass network and additionally provides improved mechanical properties and chemical durability to the glass composition and the resultant colored glass article. The amount of Al₂O₃ may also be tailored to control the viscosity of the glass composition. Al₂O₃ may be included such that the resultant glass composition has the desired fracture toughness (e.g., greater than or equal to 0.7 MPa·m^{1/2}). However, if the amount of Al₂O₃ is too high (e.g., greater than 20 mol %), the viscosity of the glass melt may increase, thereby diminishing the formability of the colored glass article.

Accordingly, in embodiments, the glass composition and the resultant colored glass article may comprise greater than or equal to 10 mol % and less than or equal to 20 mol % Al₂O₃, such as greater than or equal to 12 mol % and less than or equal to 15 mol % Al₂O₃. In embodiments, the concentration of Al₂O₃ in the glass composition and the resultant colored glass article may be greater than or equal to 11 mol %, greater than or equal to 12 mol %, greater than or equal to 13 mol %, greater than or equal to 14 mol %, greater than or equal to 15 mol %, greater than or equal to 16 mol %, greater than or equal to 17 mol %, greater than or equal to 18 mol %, greater than or equal to 19 mol %, or more. In embodiments, the concentration of Al₂O₃ in the glass composition and the resultant colored glass article may be less than or equal to 20 mol %, less than or equal to 19 mol %, less than or equal to 18 mol %, less than or equal to 17 mol %, less than or equal to 16 mol %, less than or equal to 15 mol %, less than or equal to 14 mol %, less than or equal to 13 mol %, less than or equal to 12 mol %, less than or equal to 11 mol %, or less. In embodiments, the concentration of Al₂O₃ in the glass composition and the resultant colored glass article may be greater than or equal to 10 mol % and less than or equal to 20 mol %, greater than or equal to 11 mol % and less than or equal to 19 mol %, greater than or equal to 12 mol % and less than or equal to 18 mol %, greater than or equal to 13 mol % and less than or equal to 17 mol %, greater than or equal to 14 mol % and less than or equal to 16 mol %, greater than or equal to 12 mol % and less than or equal to 15 mol %, or any and all sub-ranges formed from any of these endpoints.

The glass compositions described herein may include B₂O₃. The inclusion of B₂O₃ helps improve the damage resistance of the resultant colored glass article. In addition, B₂O₃ reduces the formation of non-bridging oxygen, the presence of which may reduce fracture toughness. However, if B₂O₃ is too high (e.g., greater than 10 mol %), the annealing point and strain point may decrease, which increases stress relaxation and reduces the overall strength of the colored glass article.

In embodiments, the glass composition and the resultant colored glass article may comprise greater than or equal to 0 mol % and less than or equal to 10 mol % B₂O₃, such as greater than or equal to 1 mol % and less than or equal to 5 mol %. In embodiments, the concentration of B₂O₃ in the glass composition and the resultant colored glass article may be greater than or equal to 0 mol %, greater than 0 mol %, greater than or equal to 0.1 mol %, greater than or equal to 1 mol %, greater than or equal to 2 mol %, greater than or equal to 3 mol %, greater than or equal to 4 mol %, greater than or equal to 5 mol %, greater than or equal to 6 mol %, greater than or equal to 7 mol %, greater than or equal to 8 mol %, greater than or equal to 9 mol %, or more. In embodiments, the concentration of B₂O₃ in the glass composition and the resultant colored glass article may be less than or equal to 10 mol %, less than or equal to 9 mol %, less than or equal to 8 mol %, less than or equal to 7 mol %, less than or equal to 6 mol %, less than or equal to 5 mol %, less than or equal to 4 mol %, less than or equal to 3 mol %, less than or equal to 2 mol %, less than or equal to 1 mol %, or less. In embodiments, the concentration of B₂O₃ in the glass composition and the resultant colored glass article may be greater than or equal to 0 mol % and less than or equal to 10 mol %, greater than 0 mol % and less than or equal to 9 mol %, greater than or equal to 0.1 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0 mol % and less than or equal to 4 mol %, or any and all sub-ranges formed from any of these endpoints. In embodiments, the glass composition and the resultant colored glass article may be substantially free or free of B₂O₃.

As described hereinabove, the glass compositions and the resultant colored glass articles contain alkali oxides, such as Li₂O, Na₂O, and K₂O, to enable the ion-exchangeability of the colored glass articles.

Li₂O aids in the ion-exchangeability of the colored glass article and also reduces the softening point of the glass composition, thereby increasing the formability of the colored glass articles. In addition, Li₂O decreases the melting point of the glass composition, which may help improve Au retention. The concentration of Li₂O in the glass compositions and resultant colored glass articles should be sufficiently high to reduce the melting point of the glass composition and achieve the desired maximum central tension following ion-exchange. However, if the amount of Li₂O is too high (e.g., greater than 20 mol %), the liquidus temperature may increase, thereby diminishing the manufacturability of the colored glass article.

In embodiments, the glass composition and the resultant colored glass article may comprise greater than or equal to 5 mol % and less than or equal to 20 mol % Li₂O, such as greater than or equal to 7 mol % and less than or equal to 8 mol % Li₂O. In embodiments, the concentration of Li₂O in the glass composition and the resultant colored glass article may be greater than or equal to 5 mol %, greater than or equal to 7 mol %, greater than or equal to 9 mol %, greater than or equal to 11 mol %, greater than or equal to 13 mol %, greater than or equal to 15 mol %, greater than or equal to 17 mol %, greater than or equal to 19 mol %, or more.

In embodiments, the concentration of Li₂O in the glass composition and the resultant colored glass article may be less than or equal to 20 mol %, less than or equal to 18 mol %, less than or equal to 16 mol %, less than or equal to 14 mol %, less than or equal to 12 mol %, less than or equal to 10 mol %, less than or equal to 8 mol %, less than or equal to 6 mol %, less than or equal to 4 mol %, less than or equal to 2 mol %, or less. In embodiments, the concentration of Li₂O in the glass composition and the resultant colored glass article may be greater than or equal to 5 mol % and less than or equal to 20 mol %, greater than or equal to 6 mol % and less than or equal to 19 mol %, greater than or equal to 7 mol % and less than or equal to 18 mol %, greater than or equal to 8 mol % and less than or equal to 17 mol %, greater than or equal to 9 mol % and less than or equal to 16 mol %, greater than or equal to 10 mol % and less than or equal to 15 mol %, greater than or equal to 11 mol % and less than or equal to 14 mol %, greater than or equal to 12 mol % and less than or equal to 13 mol %, or any and all sub-ranges formed from any of these endpoints.

Na₂O improves diffusivity of alkali ions in the glass and thereby reduces ion-exchange time and helps achieve the desired surface compressive stress. Na₂O also improves the formability of the colored glass article, with a relatively high concentration of Na₂O (e.g, greater than or equal to 2 mol %) increasing liquidus viscosity. However, if too much Na₂O is added to the glass composition, the melting point may be too low. As such, in embodiments, the concentration of Li₂O present in the glass composition and the resultant colored glass article may be greater than the concentration of Na₂O present in the glass composition and the resultant colored glass article.

In embodiments, the glass composition and the resultant colored glass article may comprise greater than or equal to 5 mol % and less than or equal to 15 mol % Na₂O, such as greater than or equal to 5 mol % and less than or equal to 7 mol % Na₂O. In embodiments, the concentration of Na₂O in the glass composition and the resultant colored glass article may be greater than or equal to 5 mol %, greater than or equal to 6 mol %, greater than or equal to 7 mol %, greater than or equal to 8 mol %, greater than or equal to 9 mol %, greater than or equal to 10 mol %, greater than or equal to 11 mol %, greater than or equal to 12 mol %, greater than or equal to 13 mol %, greater than or equal to 14 mol %, or more. In embodiments, the concentration of Na₂O in the glass composition and the resultant colored glass article may be less than or equal to 15 mol %, less than or equal to 14 mol %, less than or equal to 13 mol %, less than or equal to 12 mol %, less than or equal to 11 mol %, less than or equal to 10 mol %, less than or equal to 9 mol %, less than or equal to 8 mol %, less than or equal to 7 mol %, less than or equal to 6 mol %, or less. In embodiments, the concentration of Na₂O in the glass composition and the resultant colored glass article may be greater than or equal to 5 mol % and less than or equal to 15 mol %, greater than or equal to 6 mol % and less than or equal to 14 mol %, greater than or equal to 7 mol % and less than or equal to 13 mol %, greater than or equal to 8 mol % and less than or equal to 12 mol %, greater than or equal to 9 mol % and less than or equal to 11 mol %, greater than or equal to 5 mol % and less than or equal to 10 mol %, or any and all sub-ranges formed from any of these endpoints.

In embodiments, the glass composition and the resultant colored glass article may comprise greater than or equal to 2 mol % and less than or equal to 15 mol % Na₂O. In embodiments, the concentration of Na₂O in the glass composition and the resultant colored glass article may be greater than or equal to 2 mol %, greater than or equal to 4 mol %, or more. In embodiments, the concentration of Na₂O in the glass composition and the resultant colored glass article may be less than or equal to 15 mol %, less than or equal to 12 mol %, less than or equal to 10 mol %, or less. In embodiments, the concentration of Na₂O in the glass composition and the resultant colored glass article may be greater than or equal to 2 mol % and less than or equal to 15 mol %, greater than or equal to 3 mol % and less than or equal to 12 mol %, greater than or equal to 4 mol % and less than or equal to 10 mol %, or any and all sub-ranges formed from any of these endpoints.

K₂O promotes ion-exchange and may increase the depth of compression and decrease the melting point to improve the formability of the colored glass article. However, adding too much K₂O may cause the surface compressive stress and melting point to be too low. Accordingly, in embodiments, the amount of K₂O added to the glass composition may be limited.

In embodiments, the glass composition and the resultant colored glass article may comprise greater than 0 mol % and less than or equal to 1 mol % K₂O, such as greater than 0.1 mol % and less than or equal to 0.5 mol %. In embodiments, the concentration of K₂O in the glass composition and the resultant colored glass article may be greater than 0 mol %, greater than or equal to 0.1 mol %, or more. In embodiments, the concentration of K₂O in the glass composition and the resultant colored glass article may be less than or equal to 1 mol %, less than or equal to 0.5 mol %, less than or equal to 0.25 mol %, or less. In embodiments, the concentration of K₂O in the glass composition and the resultant colored glass article may be greater than 0 mol % and less than or equal to 1 mol %, greater than or equal to 0.1 mol % and less than or equal to 0.9 mol %, greater than or equal to 0.2 mol % and less than or equal to 0.8 mol %, greater than or equal to 0.3 mol % and less than or equal to 0.7 mol %, greater than or equal to 0.4 mol % and less than or equal to 0.5 mol %, greater than or equal to 0.1 mol % and less than or equal to 0.5 mol %, or any and all sub-ranges formed from any of these endpoints.

As used herein, R₂O is the sum (in mol %) of Li₂O, Na₂O, K₂O, Rb₂O, and Cs₂O (i.e., R₂O=Li₂O (mol %)+Na₂O (mol %)+K₂O (mol %)+Rb₂O (mol %)+Cs₂O (mol %)) present in the glass composition. As noted herein, alkali oxides, such as Na₂O, K₂O, and Li₂O, aid in decreasing the softening point and molding temperature of the glass composition, thereby offsetting the increase in the softening point and molding temperature of the glass composition due to higher amounts of SiO₂ in the glass composition, for example. The decrease in the softening point and molding temperature may be further reduced by including combinations of alkali oxides (e.g., two or more alkali oxides) in the glass composition, a phenomenon referred to as the “mixed alkali effect.” However, it has been found that if the amount of alkali oxide is too high, the average coefficient of thermal expansion of the glass composition increases to greater than 100×10⁻⁷/° C., which may be undesirable.

In embodiments, the concentration of R₂O in the glass composition and the resultant colored glass article may be greater than or equal to 10 mol % and less than or equal to 25 mol %, such as greater than or equal to 12 mol % and less than or equal to 15 mol %. In embodiments, the concentration of R₂O in the glass composition and the resultant colored glass article may be greater than or equal to 10 mol %, greater than or equal to 12 mol %, greater than 14 mol %, greater than or equal to 16 mol %, greater than or equal to 18 mol %, greater than or equal to 20 mol %, greater than or equal to 22 mol %, greater than or equal to 24 mol %, or more. In embodiments, the concentration of R₂O in the glass composition and the resultant colored glass article may be less than or equal to 25 mol %, less than or equal to 23 mol %, less than or equal to 21 mol %, less than or equal to 19 mol %, less than or equal to 17 mol %, less than or equal to 15 mol %, less than or equal to 13 mol %, less than or equal to 11 mol %, or less. In embodiments, the concentration of R₂O in the glass composition and the resultant colored glass article may be greater than or equal to 10 mol % and less than or equal to 25 mol %, greater than or equal to 11 mol % and less than or equal to 24 mol %, greater than or equal to 12 mol % and less than or equal to 23 mol %, greater than or equal to 13 mol % and less than or equal to 22 mol %, greater than or equal to 14 mol % and less than or equal to 21 mol %, greater than or equal to 15 mol % and less than or equal to 20 mol %, greater than or equal to 16 mol % and less than or equal to 19 mol %, greater than or equal to 17 mol % and less than or equal to 18 mol %, or any and all sub-ranges formed from any of these endpoints.

In embodiments, the difference between R₂O and Al₂O₃ (i.e. R₂O (mol %)-Al₂O₃ (mol %)) in the glass composition may be adjusted to produce a desired observable color (e.g., pink, purple, red, or orange). Along with the temperature and time of the heat treatment, the analyzed R₂O—Al₂O₃ of the resultant colored glass article may correlate with the observable color of the colored glass article after heat treatment, as discussed herein. In embodiments, R₂O—Al₂O₃ in the glass composition and the resultant colored glass article may be greater than or equal to −4 mol % and less than or equal to 4 mol % or greater than or equal to −3 mol % and less than or equal to 2 mol %. In embodiments, R₂O—Al₂O₃ in the glass composition and the resultant colored glass article may be greater than or equal to −4 mol % and less than or equal to 4 mol %, greater than or equal to −3 mol % and less than or equal to 3 mol %, greater than or equal to −2 mol % and less than or equal to 2 mol %, greater than or equal to −1 mol % and less than or equal to 1 mol %, greater than or equal to −3 mol % and less than or equal to 0 mol %, or any and all sub-ranges formed from any of these endpoints.

The glass compositions and the resultant colored glass articles described herein may further comprise Fe₂O₃. Fe₂O₃ may also act as a colorant in addition to Au, producing colored glass articles that may, for example, be pink or red in color. In embodiments, the glass composition and the resultant colored glass article may comprise greater than or equal to 0 mol % and less than or equal to 0.1 mol % Fe₂O₃, such as greater than or equal to 0.01 mol % and less than or equal to 0.1 mol %. In embodiments, the glass composition and the resultant colored glass article may be substantially free or free of Fe₂O₃.

The glass compositions and the resultant colored glass articles described herein may further comprise one or more fining agents. In embodiments, the fining agents may include, for example, SnO₂. In embodiments, the glass composition and the resultant colored glass article may comprise greater than or equal to 0 mol % and less than or equal to 0.5 mol % SnO₂, such as greater than or equal to 0.01 mol % and less than or equal to 0.1 mol %. In embodiments, the glass composition and the resultant colored glass article may be substantially free or free of SnO₂.

In embodiments, the glass composition and the resultant colored glass article may include alkaline earth oxides, such as MgO, CaO, SrO, and BaO, and may also include ZnO.

MgO may lower the liquidus viscosity of a glass and improve the melting behavior, which enhances the formability and manufacturability of the glass. The inclusion of MgO in a glass composition may also improve the strain point and the Young's modulus of the glass composition. However, if too much MgO is added to the glass composition (e.g., greater than 8 mol %), the liquidus viscosity may be too low for compatibility with desirable forming techniques. In embodiments, the concentration of MgO in the glass composition and the resultant colored glass article may be greater than or equal to 0 mol % and less than or equal to 8 mol %, such as greater than or equal to 0 mol % or even greater than or equal to 2 mol %. In embodiments, the concentration of MgO in the glass composition and the resultant colored glass article may be greater than or equal to 0 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0.1 mol % and less than or equal to 4 mol %, or any and all sub-ranges formed from any of these endpoints. In embodiments, the glass composition and the resultant colored glass article may be substantially free or free of MgO.

In embodiments, the concentration of MgO in the glass composition and the resultant colored glass article may be greater than or equal to 0 mol % and less than or equal to 8 mol %, greater than or equal to 0.1 and less than or equal to 6 mol %, greater than or equal to 0.25 mol % and less than or equal to 4 mol %, greater than or equal to 0.5 mol % and less than or equal to 2 mol %, greater than or equal to 0.75 mol % and less than or equal to 1 mol %, or any and all sub-ranges formed from any of these endpoints.

In embodiments, the concentration of CaO in the glass composition and the resultant colored glass article may be greater than or equal to 0 mol % and less than or equal to 8 mol %, such as greater than or equal to 0 mol % or even greater than or equal to 2 mol %. In embodiments, the concentration of CaO in the glass composition and the resultant colored glass article may be greater than or equal to 0 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0.1 mol % and less than or equal to 4 mol %, or any and all sub-ranges formed from any of these endpoints. In embodiments, the glass composition and the resultant colored glass article may be substantially free or free of CaO.

In embodiments, the concentration of ZnO in the glass composition and the resultant colored glass article may be greater than or equal to 0 mol % and less than or equal to 8 mol %, such as greater than or equal to 0 mol % or even greater than or equal to 2 mol %. In embodiments, the concentration of ZnO in the glass composition and the resultant colored glass article may be greater than or equal to 0 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0.1 mol % and less than or equal to 4 mol %, or any and all sub-ranges formed from any of these endpoints. In embodiments, the glass composition and the resultant colored glass article may be substantially free or free of ZnO.

As used herein, R′O is the sum (in mol %) of MgO, BaO, CaO, SrO, BeO, and ZnO (i.e., R′O=MgO (mol %)+BaO (mol %)+CaO (mol %)+SrO (mol %)+BeO (mol %)+ZnO (mol %)) present in the glass composition. The concentration of R′O in the glass composition and the resultant colored glass article may be greater than or equal to 0 mol % to less than or equal to 8 mol %, such as greater than or equal to 1 mol % to less than or equal to 3 mol %. In embodiments, the concentration of R′O in the glass composition and the resultant colored glass article may be greater than or equal to 0 mol % and less than or equal to 8 mol %, greater than or equal to 1 mol % and less than or equal to 7 mol %, greater than or equal to 2 mol % and less than or equal to 6 mol %, greater than or equal to 3 mol % and less than or equal to 5 mol %, greater than or equal to 0.1 mol % and less than or equal to 4 mol %, or any and all sub-ranges formed from any of these endpoints. In embodiments, the glass composition and the resultant colored glass article may be substantially free or free of R′O.

As described herein, the glass compositions and the resultant colored glassed articles described herein include a relatively low Li₂O concentration (e.g., less than or equal to 20 mol %) and a relatively low MgO concentration (e.g., less than or equal to 8 mol %) to achieve a desired liquidus viscosity (e.g., greater than or equal to 50 kP) and a desired liquidus temperature (e.g., less than or equal to 1300° C.). Accordingly, the sum of Li₂O and MgO (i.e., Li₂O (mol %)+MgO (mol %) may similarly be relatively low (e.g., less than or equal to 20 mol %) to achieve a desired liquidus viscosity and liquidus temperature. In embodiments, the Li₂O+MgO in the glass composition and the resultant colored glass article may be greater than or equal to 5 mol % and less than or equal to 20 mol %. In embodiments, Li₂O+MgO in the glass composition and the resultant colored glass article may be greater than or equal to 5 mol %, greater than or equal to 6 mol %, greater than or equal to 7 mol %, or more. In embodiments, Li₂O+MgO in the glass composition and the resultant colored glass article may be less than or equal to 20 mol %, less than or equal to 15 mol %, less than or equal to 10 mol %, or less. In embodiments, Li₂O+MgO in the glass composition and the resultant colored glass article may be greater than or equal to 5 mol % and less than or equal to 20 mol %, greater than or equal to 6 mol % and less than or equal to 15 mol %, greater than or equal to 7 mol % and less than or equal to 10 mol %, or any and all sub-ranges formed from any of these endpoints.

The glass compositions and the resultant colored glass articles described herein include Au as a colorant to achieve the desired color. In embodiments, the glass composition and the resultant colored glass article may include Au in a concentration greater than or equal to 0.0001 mol %, such as greater than or equal to 0.0003 mol % and less than or equal to 0.0082 mol % Au. In embodiments, the concentration of Au in the glass composition and the resultant colored glass article may be greater than or equal to 0.0001 mol %, greater than or equal to 0.0002 mol %, greater than or equal to 0.0003 mol %, greater than or equal to 0.0004 mol %, greater than or equal to 0.0005 mol %, greater than or equal to 0.0006 molo, greater than or equal to 0.0007 mol %, greater than or equal to 0.0008 mol %, greater than or equal to 0.0009 mol %, greater than or equal to 0.001 mol %, greater than or equal to 0.002 mol %, greater than or equal to 0.003 mol %, greater than or equal to 0.004 mol %, greater than or equal to 0.005 mol %, greater than or equal to 0.006 mol %, greater than or equal to 0.007 mol %, greater than or equal to 0.008 mol %, greater than or equal to 0.009 mol %, greater than or equal to 0.01 mol %, or more. In embodiments, the concentration of Au in the glass composition and the resultant colored glass article may be less than or equal to 0.01 mol %, less than or equal to 0.009 mol %, less than or equal to 0.008 mol %, less than or equal to 0.007 mol %, less than or equal to 0.006 mol %, less than or equal to 0.005 mol %, less than or equal to 0.004 mol %, less than or equal to 0.003 mol %, less than or equal to 0.002 mol %, less than or equal to 0.001 mol %, less than or equal to 0.0009 mol %, less than or equal to 0.0008 mol %, less than or equal to 0.0007 mol %, less than or equal to 0.0006 mol %, less than or equal to 0.0005 mol %, less than or equal to 0.0004 mol %, less than or equal to 0.0003 mol %, or less. In embodiments, the concentration of Au in the glass composition and the resultant colored glass article may be greater than or equal to 0.0001 mol % and less than or equal to 0.1 mol %, greater than or equal to 0.0002 mol % and less than or equal to 0.09 mol %, greater than or equal to 0.0003 mol % and less than or equal to 0.08 mol %, greater than or equal to 0.0003 mol % and less than or equal to 0.07 mol %, greater than or equal to 0.0004 mol % and less than or equal to 0.06 mol %, greater than or equal to 0.0005 mol % and less than or equal to 0.05 mol %, greater than or equal to 0.0006 mol % and less than or equal to 0.04 mol %, greater than or equal to 0.0007 mol % and less than or equal to 0.03 mol %, greater than or equal to 0.0008 mol % and less than or equal to 0.02 mol %, greater than or equal to 0.0009 mol % and less than or equal to 0.01 mol %, greater than or equal to 0.001 mol % and less than or equal to 0.009 mol %, greater than or equal to 0.002 mol % and less than or equal to 0.008 mol %, greater than or equal to 0.003 mol % and less than or equal to 0.007 mol %, greater than or equal to 0.004 mol % and less than or equal to 0.006 mol %, greater than or equal to 0.001 mol % and less than or equal to 0.005 mol %, or any and all sub-ranges formed from any of these endpoints.

In embodiments, the glass composition and the resultant colored glass article may include Au in a concentration greater than or equal to 1×10⁻⁶ mol %, greater than or equal to 1×10⁻⁵ mol %, greater than or equal to 0.0001 mol %, or more. In embodiments, the concentration of Au in the glass composition and the resultant colored glass article may be less than or equal to 0.01 mol %, less than or equal to 0.005 mol %, less than or equal to 0.001 mol %, or less. In embodiments, the concentration of Au in the glass composition and the result colored glass article may be greater than or equal to 1×10⁻⁶ mol % and less than or equal to 0.01 mol %, greater than or equal to 1×10⁻⁵ mol % and less than or equal to 0.005 mol %, greater than or equal to 0.0001 mol % and less than or equal to 0.001 mol %, or any and all sub-ranges formed from any of these endpoints. One skilled in the art would appreciate that the relatively low concentrations of Au described herein may provide color(s) as disclosed herein.

In embodiments, the glass composition and the resultant colored glass article may include Au in a concentration greater than or equal to 0.01 ppm, greater than or equal to 0.1 ppm, greater than or equal to 1 ppm, or more. In embodiments, the concentration of Au in the glass composition and the resultant colored glass article may be less than or equal to 500 ppm, less than or equal to 250 ppm, less than or equal to less than or equal to 100 ppm, less than or equal to 50 ppm, less than or equal to 10 ppm, or less. In embodiments, the concentration of Au in the glass composition and the result colored glass article may be greater than or equal to 0.01 ppm and less than or equal to 500 ppm, greater than or equal to 0.1 ppm and less than or equal to 250 ppm, greater than or equal to 1 ppm and less than or equal to 100 ppm, greater than or equal to 0.01 ppm and less than or equal to 50 ppm, greater than or equal to 0.1 ppm and less than or equal to 10 ppm, or any and all sub-ranges formed from any of these endpoints.

The glass compositions and the resultant colored glass articles described herein may include Ag as an additional colorant to achieve the desired color. In embodiments, the glass composition and the resultant colored glass article may include Ag in a concentration greater than or equal to 0 mol % and less than or equal to 0.2 mol %, such as greater than 0 mol % and less than or equal to 0.15 mol %. In embodiments, the concentration of Ag in the glass composition and the resultant colored glass article may be greater than or equal to 0 mol %, greater than 0 mol %, greater than or equal to 0.01 mol %, greater than or equal to 0.02 mol %, greater than or equal to 0.03 mol %, greater than or equal to 0.04 mol %, greater than or equal to 0.05 mol %, greater than or equal to 0.06 mol %, greater than or equal to 0.07 mol %, greater than or equal to 0.08 mol %, greater than or equal to 0.09 mol %, greater than or equal to 0.10 mol %, greater than or equal to 0.11 mol %, greater than or equal to 0.12 mol %, greater than or equal to 0.13 mol %, greater than or equal to 0.14 mol %, greater than or equal to 0.15 mol %, greater than or equal to 0.16 mol %, greater than or equal to 0.17 mol %, greater than or equal to 0.18 mol %, greater than or equal to 0.19 mol %, or more. In embodiments, the concentration of Ag in the glass composition and the resultant colored glass article may be less than or equal to 0.2 mol %, less than or equal to 0.19 mol %, less than or equal to 0.18 mol %, less than or equal to 0.17 mol %, less than or equal to 0.16 mol %, less than or equal to 0.15 mol %, less than or equal to 0.14 mol %, less than or equal to 0.13 mol %, less than or equal to 0.12 mol %, less than or equal to 0.11 mol %, less than or equal to 0.10 mol %, less than or equal to 0.09 mol %, less than or equal to 0.08 mol %, less than or equal to 0.07 mol %, less than or equal to 0.06 mol %, less than or equal to 0.05 mol %, less than or equal to 0.04 mol %, less than or equal to 0.03 mol %, less than or equal to 0.01 mol %, or less. In embodiments, the concentration of Ag in the glass composition and the resultant colored glass article may be greater than or equal to 0 mol % and less than or equal to 0.2 mol %, greater than 0 mol % and less than or equal to 0.19 mol %, greater than or equal to 0.01 mol % and less than or equal to 0.18 mol %, greater than or equal to 0.02 mol % and less than or equal to 0.17 mol %, greater than or equal to 0.03 mol % and less than or equal to 0.16 mol %, greater than or equal to 0.04 mol % and less than or equal to 0.15 mol %, greater than or equal to 0.05 mol % and less than or equal to 0.14 mol %, greater than or equal to 0.06 mol % and less than or equal to 0.13 mol %, greater than or equal to 0.07 mol % and less than or equal to 0.12 mol %, greater than or equal to 0.08 mol % and less than or equal to 0.11 mol %, greater than or equal to 0.09 mol % and less than or equal to 0.10 mol %, or any and all sub-ranges formed from any of these endpoints. In embodiments, the glass composition and the resultant colored glass article may be substantially free or free of Ag.

In embodiments, the concentration of Ag in the glass composition and the resultant colored glass article may be greater than or equal to 0 mol %, greater than or equal to 0.001 mol %, greater than or equal to 0.01 mol %, greater than or equal to 0.1 mol %, or more. In embodiments, the concentration of Ag in the glass composition and the resultant colored glass article may be less than or equal to 0.2 mol %, less than or equal to 0.17 mol %, less than or equal to 0.15 mol %, less than or equal to 0.13 mol %, or less. In embodiments, the concentration of Ag in the glass composition and the resultant colored glass article may be greater than or equal to 0 mol % and less than or equal to 0.2 mol %, greater than or equal to 0.001 mol % and less than or equal to 0.17 mol %, greater than or equal to 0.01 mol % and less than or equal to 0.15 mol %, greater than or equal to 0.1 mol % and less than or equal to 0.13 mol %, or any and all sub-ranges formed from any of these endpoints. One skilled in the art would appreciate that the relatively low concentrations of Ag described herein may provide color(s) as disclosed herein.

In embodiments, the concentration of Ag in the glass composition and the resultant colored glass article may be greater than or equal to 0 ppm, greater than or equal to 10 ppm, greater than or equal to 100 ppm, greater than or equal to 1000 ppm, or more. In embodiments, the concentration of Ag in the glass composition and the resultant colored glass article may be less than or equal to 4000 pm, less than or equal to 3500 ppm, less than or equal to 3000 ppm, less than or equal to 2500 ppm, less than or equal to 2000 ppm or less. In embodiments, the concentration of Ag in the glass composition and the resultant colored glass article may be greater than or equal to 0 ppm and less than or equal to 4000 ppm, greater than or equal to 10 ppm and less than or equal to 3500 ppm, greater than or equal to 100 ppm and less than or equal to 3000 ppm, greater than or equal to 1000 ppm and less than or equal to 2500 ppm, greater than or equal to 0 ppm and less than or equal to 2000 ppm, or any and all sub-ranges formed from any of these endpoints.

The glass compositions and the resultant colored glass articles described herein may include MnO₂ as an additional colorant to achieve the desired color. In embodiments, the glass composition and the resultant colored glass article may include MnO₂ in a concentration greater than or equal to 0 mol % and less than or equal to 0.5 mol %, such as greater than or equal to 0.01 mol % and less than or equal to 0.4 mol %. In embodiments, the concentration of MnO₂ in the glass composition and the resultant colored glass article may be greater than or equal to 0 mol %, greater than 0 mol %, greater than or equal to 0.01 mol %, greater than or equal to 0.05 mol %, greater than or equal to 0.1 mol %, greater than or equal to 0.2 mol %, greater than or equal to 0.3 mol %, greater than or equal to 0.4 mol %, or more. In embodiments, the concentration of MnO₂ in the glass composition and the resultant colored glass article may be less than or equal to 0.5 mol %, less than or equal to 0.4 mol %, less than or equal to 0.3 mol %, less than or equal to 0.2 mol %, less than or equal to 0.1 mol %, less than or equal to 0.05 mol %, or less. In embodiments, the concentration of MnO₂ in the glass composition and the resultant colored glass article may be greater than or equal to 0 mol % to less than or equal to 0.5 mol %, greater than 0 mol % to less than or equal to 0.4 mol %, greater than or equal to 0.01 mol % to less than or equal to 0.3 mol %, greater than or equal to 0.05 mol % to less than or equal to 0.2 mol %, greater than or equal to 0.1 mol % to less than or equal to 0.5 mol %, or any and all sub-ranges formed from any of these endpoints. In embodiments, the glass composition and the resultant colored glass article may be substantially free or free of MnO₂.

The glass compositions and the resultant colored glass articles described herein may include Bi₂O₃ as an additional colorant to achieve the desired color. In embodiments, the glass composition and the resultant colored glass article may include Bi₂O₃ in a concentration greater than or equal to 0 mol % and less than or equal to 0.5 mol %, such as greater than or equal to 0.01 mol % and less than or equal to 0.2 mol %. In embodiments, the concentration of Bi₂O₃ in the glass composition and the resultant colored glass article may be greater than or equal to 0 mol %, greater than 0 mol %, greater than or equal to 0.01 mol %, greater than or equal to 0.05 mol %, greater than or equal to 0.1 mol %, greater than or equal to 0.2 mol %, greater than or equal to 0.3 mol %, greater than or equal to 0.4 mol %, or more. In embodiments, the concentration of Bi₂O₃ in the glass composition and the resultant colored glass article may be less than or equal to 0.5 mol %, less than or equal to 0.4 mol %, less than or equal to 0.3 mol %, less than or equal to 0.2 mol %, less than or equal to 0.1 mol %, less than or equal to 0.05 mol %, or less. In embodiments, the concentration of Bi₂O₃ in the glass composition and the resultant colored glass article may be greater than or equal to 0 mol % to less than or equal to 0.5 mol %, greater than 0 mol % to less than or equal to 0.4 mol %, greater than or equal to 0.01 mol % to less than or equal to 0.3 mol %, greater than or equal to 0.05 mol % to less than or equal to 0.2 mol %, greater than or equal to 0.1 mol % to less than or equal to 0.5 mol %, or any and all sub-ranges formed from any of these endpoints. In embodiments, the glass composition and the resultant colored glass article may be substantially free or free of Bi₂O₃.

In embodiments, the glass compositions may include Pt. The Pt may be a result of interactions between the glass composition and the melting and/or forming equipment. In embodiments, the glass compositions and the resultant colored glass articles described herein may include Pt in a concentration greater than or equal to 0 mol % to less than or equal to 0.001 mol %, such as greater than 0 mol % to less than or equal to 0.001 mol %, or any and all sub-ranges formed from any of these endpoints. In embodiments, the glass composition and the resultant colored glass article may be substantially free or free of Pt.

In embodiments, the glass compositions and the resultant colored glass articles described herein may further include tramp materials such as TiO₂, MoO₃, WO₃, Y₂O₃, CdO, As₂O₃, sulfur-based compounds, such as sulfates, halogens, or combinations thereof. In embodiments, the glass composition and the resultant colored glass article may be substantially free or free of tramp materials such as TiO₂, MoO₃, WO₃, Y₂O₃, CdO, As₂O₃, sulfur-based compounds, such as sulfates, halogens, or combinations thereof. In embodiments, antimicrobial components, chemical fining agents, or other additional components may be included in the glass compositions and the resultant colored glass articles.

In embodiments, the glass composition may comprise greater than or equal to 60 mol % to less than or equal to 75 mol % SiO₂, greater than or equal to 10 mol % to less than or equal to 20 mol % Al₂O₃, greater than or equal to 5 mol % to less than or equal to 20 mol % Li₂O, greater than or equal to 5 mol % to less than or equal to 15 mol % Na₂O, greater than 0 mol % to less than or equal to 1 mol % K₂O, greater than 0 mol % to less than or equal to 8 mol % MgO, and greater than or equal to 0.0001 mol % to less than or equal to 0.01 mol % Au.

In embodiments, a glass composition may comprise greater than or equal to 60 mol % to less than or equal to 75 mol % SiO₂, greater than or equal to 10 mol % to less than or equal to 20 mol % Al₂O₃, greater than or equal to 5 mol % to less than or equal to 20 mol % Li₂O, greater than or equal to 2 mol % to less than or equal to 15 mol % Na₂O, greater than 0 mol % to less than or equal to 1 mol % K₂O, greater than 0 mol % to less than or equal to 8 mol % MgO, and greater than or equal to 0.0001 mol % to less than or equal to 0.01 mol % Au

The glass compositions described herein have liquidus viscosities that are compatible with manufacturing processes that are especially suitable for forming thin glass sheets. For example, the glass compositions are compatible with down draw processes such as fusion draw processes or slot draw processes. Embodiments of the glass-based substrates may be described as fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based article. The fusion of the glass films produces a fusion line within the glass-based substrate, and this fusion line allows glass-based substrates that were fusion formed to be identified without additional knowledge of the manufacturing history. The fusion draw method offers the advantage that, because the two glass films flowing over the channel fuse together, neither of the outside surfaces of the resulting glass-based article comes in contact with any part of the apparatus. Thus, the surface properties of the fusion drawn glass-based article are not affected by such contact.

The glass compositions described have liquidus viscosities that are compatible with fusion draw processes. Thus, the glass compositions described herein are compatible with existing forming methods, increasing the manufacturability of glass-based articles formed from the glass compositions. As used herein, the term “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed in this application is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. The term “Vogel-Fulcher-Tamman (‘VFT’) relation,” as used herein, described the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 P Temperature, 35000P Temperature, and 200000 P Temperature) at any temperature above softening point may be calculated. Unless otherwise specified, the liquidus viscosity and temperature of a glass composition or article is measured before the composition or article is subjected to any ion-exchange process or any other strengthening process. In particular, the liquidus viscosity and temperature of a glass composition or article is measured before the composition or article is exposed to an ion-exchange solution, for example before being immersed in an ion-exchange solution.

In embodiments, the liquidus viscosity of the glass composition may be greater than or equal to 100 kP, such as greater than or equal to 110 kP, greater than or equal to 120 kP, greater than or equal to 130 kP, greater than or equal to 140 kP, greater than or equal to 150 kP, greater than or equal to 160 kP, greater than or equal to 170 kP, greater than or equal to 180 kP, greater than or equal to 190 kP, greater than or equal to 200 kP, greater than or equal to 250 kP, greater than or equal to 300 kP, greater than or equal to 350 kP, greater than or equal to 400 kP, greater than or equal to 450 kP, greater than or equal to 500 kP, or more. In embodiments, the liquidus viscosity of the glass composition may be greater than or equal to 100 kP to less than or equal to 600 kP, such as greater than or equal to 110 kP to less than or equal to 550 kP, greater than or equal to 120 kP to less than or equal to 500 kP, greater than or equal to 130 kP to less than or equal to 450 kP, greater than or equal to 140 kP to less than or equal to 400 kP, greater than or equal to 150 kP to less than or equal to 350 kP, greater than or equal to 160 kP to less than or equal to 300 kP, greater than or equal to 170 kP to less than or equal to 250 kP, greater than or equal to 180 kP to less than or equal to 200 kP, greater than or equal to 190 kP to less than or equal to 600 kP, and all ranges and sub-ranges between the foregoing values. In embodiments, the liquidus viscosity of the glass composition may be greater than or equal to 50 kP, such as greater than or equal to 75 kP, greater than or equal to 100 kP, greater than or equal to 125 kP, greater than or equal to 150 kP, greater than or equal to 175 kP, greater than or equal to 200 kP, or more. In embodiments, the liquidus viscosity of the glass composition may be greater than or equal to 50 kP to less than or equal to 600 kP, such as greater than or equal to 75 kP to less than or equal to 550 kP, greater than or equal to 100 kP to less than or equal to 500 kP, greater than or equal to 125 kP to less than or equal to 450 kP, greater than or equal to 150 kP to less than or equal to 400 kP, greater than or equal to 175 kP to less than or equal to 350 kP, greater than or equal to 200 kP to less than or equal to 300 kP, or all ranges and sub-ranges between the forgoing values. A lower liquidus viscosity has been associated with higher K_{IC} values and improved ion exchange capability, but when the liquidus viscosity is too low the manufacturability of the glass compositions is reduced. Stated differently, a higher liquidus viscosity is generally more compatible with fusion forming processes. In embodiments, the log₁₀ liquidus viscosity of the glass composition may be greater than or equal to 4.9 P, greater than or equal to 5.0 P, greater than or equal to 5.1 P, greater than or equal to 5.2 P, greater than or equal to 5.3 P, or more. It has been observed that when the glass composition forms a slow growing crystalline phase, such as cristobalite, lower liquidus viscosity values (e.g. greater than or equal to 100 kP) are possible for fusion forming without forming crystalline or Au inclusions, but for faster growing crystalline phases a higher liquidus viscosity may be beneficial (e.g. greater than or equal to 200 kP).

In embodiments, the liquidus temperature of the glass composition may be less than or equal to 1300° C., such as less than or equal to 1250° C., less than or equal to 1200° C., less than or equal to 1150° C., or less. In embodiments, the liquidus temperature of the glass composition may be greater than or equal to 1100° C. to less than or equal to 1300° C., such as greater than or equal to 1150° C. to less than or equal to 1250° C., greater than or equal to 1100° C. to less than or equal to 1200° C., and all ranges and sub-ranges between the foregoing values. Higher liquidus temperatures are associated with increased devitrification of the glass (e.g. formation of Au particle defects) during the fusion forming process, and as a result lower liquidus temperatures are preferred. Relatively low liquidus temperatures (e.g., less than or equal to 1300° C.) may correspond with relatively high liquidus viscosities (e.g., greater than or equal to 50 kP).

In embodiments, the 200 P temperature of the glass composition may be less than or equal to 1700° C. In embodiments, the zircon breakdown temperature of the glass compositions may be greater than the 35 kP temperature of the glass composition.

In embodiments, the colored glass article may have a transmittance color coordinate in the CIELAB color space, as measured under F2 illumination and a 10° standard observer angle, of: L* greater than or equal to 50 and less than or equal to 98; a* greater than or equal to −5 and less than or equal to 25; and b* greater than or equal to −20 and less than or equal to 60. In embodiments, the colored glass article may have a transmittance color coordinate in the CIELAB color space, as measured under F2 illumination and a 100 standard observer angle, of L* greater than or equal to 50 and less than or equal to 98, such as greater than or equal to 70 and less than or equal to 96, greater than or equal to 55 and less than or equal to 97, greater than or equal to 60 and less than or equal to 95, greater than or equal to 65 and less than or equal to 94, greater than or equal to 75 and less than or equal to 93, greater than or equal to 80 and less than or equal to 92, greater than or equal to 85 and less than or equal to 91, greater than or equal to 70 and less than or equal to 90, or any and all sub-ranges formed from any of these endpoints. In embodiments, the colored glass article may have a transmittance color coordinate in the CIELAB color space, as measured under F2 illumination and a 100 standard observer angle, of a* greater than or equal to −5 and less than or equal to 25, such as greater than or equal to −1 and less than or equal to 21, greater than or equal to −4 and less than or equal to 20, greater than or equal to −3 and less than or equal to 15, greater than or equal to −2 and less than or equal to 10, greater than or equal to −1 and less than or equal to 5, or any and all sub-ranges formed from any of these endpoints. In embodiments, the colored glass article may have a transmittance color coordinate in the CIELAB color space, as measured under F2 illumination and a 100 standard observer angle, of b* greater than or equal to −20 and less than or equal to 60, such as greater than or equal to −14 and less than or equal to 55, greater than or equal to −15 and less than or equal to 50, greater than or equal to −10 and less than or equal to 45, greater than or equal to −5 and less than or equal to 40, greater than or equal to 0 and less than or equal to 35, greater than or equal to 5 and less than or equal to 30, greater than or equal to 10 and less than or equal to 25, greater than or equal to −20 and less than or equal to 20, or any and all sub-ranges formed from any of these endpoints.

Different color coordinates within the color gamut may be achieved by altering the heat treatment cycle used to produce the resultant colored glass articles. The heat treatment cycle is characterized by the temperature of the environment (i.e., the oven) and the duration of the cycle (i.e., the time the glass article is exposed to the heated environment). As used herein, the phrase “temperature of the heat treatment cycle” refers to the temperature of the environment (i.e., the oven). In embodiments, glass articles formed from the glass compositions described herein are heat treated in an isothermal oven to produce the resultant colored glass articles.

In embodiments, the temperature of the heat treatment cycle is greater than or equal to 500° C., greater than or equal to 550° C., greater than or equal to 575° C., greater than or equal to 600° C., greater than or equal to 625° C., greater than or equal to 650° C., greater than or equal to 675° C., greater than or equal to 700° C., greater than or equal to 725° C., greater than or equal to 750° C., greater than or equal to 775° C., or more. In embodiments, the temperature of the heat treatment cycle is less than or equal to 800° C., less than or equal to 775° C., less than or equal to 750° C., less than or equal to 725° C., less than or equal to 700° C., less than or equal to 675° C., less than or equal to 650° C., less than or equal to 625° C., less than or equal to 600° C., less than or equal to 575° C., less than or equal to 550° C., less than or equal to 525° C., or less. In embodiments, the temperature of the heat treatment cycle is greater than or equal to 500° C. and less than or equal to 800° C., greater than or equal to 525° C. and less than or equal to 775° C., greater than or equal to 550° C. and less than or equal to 750° C., greater than or equal to 575° C. and less than or equal to 725° C., greater than or equal to 600° C. and less than or equal to 700° C., greater than or equal to 625° C. and less than or equal to 675° C., greater than or equal to 500° C. and less than or equal to 650° C., or any and all sub-ranges formed from any of these endpoints.

In embodiments, the duration of the heat treatment cycle is greater than or equal to 0.25 hour, greater than or equal to 0.5 hour, greater than or equal 1 hour, greater than or equal to 2 hours, greater than or equal to 2 hours, greater than or equal to 3 hours, greater than or equal to 4 hours, greater than or equal to 5 hours, greater than or equal to 6 hours, greater than or equal 7 hours, greater than or equal to 8 hours, greater than or equal to 9 hours, greater than or equal to 10 hours, greater than or equal to 12 hours, greater than or equal to 18 hours, or more. In embodiments, the duration of the heat treatment cycle is less than or equal to 24 hours, less than or equal to 18 hours, less than or equal to 16 hours, less than or equal to 12 hours, less than or equal to 10 hours, less than or equal to 9 hours, less than or equal to 8 hours, less than or equal to 7 hours, less than or equal to 6 hours, less than or equal to 5 hours, less than or equal to 4 hours, less than or equal to 3 hours, less than or equal to 2 hours, less than or equal to 1 hour, less than or equal to 0.5 hours, or less. In embodiments, the duration of the heat treatment cycle is greater than or equal to 0.25 hours and less than or equal to 24 hours, greater than or equal to 0.5 hours and less than or equal to 18 hours, greater than or equal to 1 hour and less than or equal to 16 hours, greater than or equal to 2 hours and less than or equal to 12 hours, greater than or equal to 3 hours and less than or equal to 10 hours, greater than or equal to 4 hours and less than or equal to 9 hours, greater than or equal to 5 hours and less than or equal to 8 hours, greater than or equal to 6 hours and less than or equal to 7 hours, or any and all sub-ranges formed from any of these endpoints.

The colored glass articles formed from the glass compositions described herein may be any suitable thickness, which may vary depending on the particular application of the colored glass article. In embodiments, the colored glass articles may have a thickness greater than or equal to 250 μm and less than or equal to 6 mm, greater than or equal to 300 μm and less than or equal to 5 mm, greater than or equal to 350 μm and less than or equal to 4 mm, greater than or equal to 400 μm and less than or equal to 3.5 mm, greater than or equal to 500 μm and less than or equal to 3 μm, greater than or equal to 550 μm and less than or equal to 2.5 μm, greater than or equal to 600 μm and less than or equal to 2 mm, greater than or equal to 650 μm and less than or equal to 1.5 mm, greater than or equal to 700 μm and less than or equal to 1 mm, greater than or equal to 750 μm and less than or equal to 950 μm, greater than or equal to 800 μm and less than or equal to 900 μm, greater than or equal to 250 μm and less than or equal to 850 μm, or any and all sub-ranges formed from any of these endpoints.

In embodiments, the glass compositions described herein are ion-exchangeable to facilitate strengthening the colored glass article made from the glass compositions. In typical ion-exchange processes, smaller metal ions in the glass compositions are replaced or “exchanged” with larger metal ions of the same valence within a layer that is close to the outer surface of the colored glass article made from the glass composition. The replacement of smaller ions with larger ions creates a compressive stress within the layer of the colored glass article made from the glass composition. In embodiments, the metal ions are monovalent metal ions (e.g., Li⁺, Na⁺, K⁺, and the like), and ion-exchange is accomplished by immersing the glass article made from the glass composition in a bath comprising at least one molten salt of the larger metal ion that is to replace the smaller metal ion in the colored glass article. Alternatively, other monovalent ions such as Ag⁺, Tl⁺, Cu⁺, and the like may be exchanged for monovalent ions. The ion-exchange process or processes that are used to strengthen the colored glass article made from the glass composition may include contacting the colored glass article with an ion-exchange medium. In embodiments, the ion-exchange medium may be a molten salt bath. For example, the ion-exchange process may include, but is not limited to, immersion in a single bath or multiple baths of like or different compositions with optional washing and/or annealing steps between immersions.

Upon exposure to the colored glass article, the ion exchange solution (e.g., KNO₃ and/or NaNO₃ molten salt bath) may, according to embodiments, be at a temperature greater than or equal to 350° C. and less than or equal to 500° C., greater than or equal to 360° C. and less than or equal to 490° C., greater than or equal to 370° C. and less than or equal to 480° C., greater than or equal to 380° C. and less than or equal to 470° C., greater than or equal to 390° C. and less than or equal to 460° C., greater than or equal to 400° C. and less than or equal to 450° C., greater than or equal to 410° C. and less than or equal to 440° C., greater than or equal to 420° C. and less than or equal to 430° C., or any and all sub-ranges between the foregoing values. In embodiments, the colored glass article may be exposed to the ion exchange solution for a duration greater than or equal to 2 hours and less than or equal to 24 hours, greater than or equal to 2 hours and less than or equal to 12 hours, greater than or equal to 3 hours and less than or equal to 11 hours, greater than or equal to 4 hours and less than or equal to 10 hours, greater than or equal to 5 hours and less than or equal to 9 hours, greater than or equal to 6 hours and less than or equal to 8 hours, greater than or equal to 2 hours and less than or equal to 7 hours, or any and all sub-ranges formed from any of these endpoints.

In embodiments, a colored glass article made from a glass composition may be ion-exchanged to achieve a depth of compression greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, greater than or equal to 80 μm, greater than or equal to 90 μm, greater than or equal to 100 μm, greater than or equal to 110 μm, greater than or equal to 120 μm, greater than or equal to 130 μm, greater than or equal to 140 μm, greater than or equal to 150 μm, or more. In embodiments, the colored glass article made from the glass composition may have a thickness “t” and may be ion-exchanged to achieve a depth of compression greater than or equal to 0.15 t, greater than or equal to 0.16 t, greater than or equal to 0.17 t, greater than or equal to 0.18 t, greater than or equal to 0.19 t, greater than or equal to 0.20 t, greater than or equal to 0.21 t, or more. In embodiments, the colored glass article made from the glass composition described herein may have a thickness “t” and may be ion-exchanged to achieve a depth of compression greater than or equal to 0.15 t and less than or equal to 0.3 t, greater than or equal to 0.16 t and less than or equal to 0.29 t, greater than or equal to 0.17 t and less than or equal to 0.28 t, greater than or equal to 0.18 t and less than or equal to 0.27 t, greater than or equal to 0.19 t and less than or equal to 0.26 t, greater than or equal to 0.20 t and less than or equal to 0.25 t, greater than or equal to 0.21 t and less than or equal to 0.24 t, greater than or equal to 0.22 t and less than or equal to 0.23 t, or any and all sub-ranges formed from any of these endpoints.

The development of this surface compression layer is beneficial for achieving a better crack resistance and higher flexural strength compared to non-ion-exchanged materials. The surface compression layer has a higher concentration of the ions exchanged into the colored glass article in comparison to the concentration of the ions exchanged into the colored glass article for the body (i.e., the area not including the surface compression) of the colored glass article. In embodiments, the colored glass article made from the glass composition may have a surface compressive stress after ion-exchange strengthening greater than or equal to 300 MPa, greater than or equal to 400 MPa, greater than or equal to 500 MPa, greater than or equal to 600 MPa, greater than or equal to 700 MPa, greater than or equal to 800 MPa, greater than or equal to 900 MPa, or more. In embodiments, the colored glass article made from the glass composition may have a surface compressive stress after ion-exchange strengthening less than or equal to 1 GPa, less than or equal to 900 MPa, less than or equal to 800 MPa, less than or equal to 700 MPa, less than or equal to 600 MPa, less than or equal to 500 MPa, less than or equal to 400 MPa, or less. In embodiments, the colored glass article made from the glass composition may have a surface compressive stress after ion-exchange strengthening greater than or equal to 300 MPa and less than or equal to 1 GPa, greater than or equal to 400 MPa and less than or equal to 900 MPa, greater than or equal to 500 MPa and less than or equal to 800 MPa, greater than or equal to 600 MPa and less than or equal to 700 MPa, or any and all sub-ranges formed from any of these endpoints.

In embodiments, the colored glass articles made from the glass composition may have a maximum central tension after ion-exchange strengthening greater than or equal to 40 MPa, greater than or equal to 50 MPa, greater than or equal to 60 MPa, greater than or equal to 70 MPa, greater than or equal to 80 MPa, greater than or equal to 90 MPa, greater than or equal to 100 MPa, or more. In embodiments, the colored glass article made from the glass composition may have a maximum central tension after ion-exchange strengthening less than or equal to 250 MPa, less than or equal to 225 MPa, less than or equal to 200 MPa, less than or equal to 175 MPa, less than or equal to 150 MPa, less than or equal to 125 MPa, less than or equal to 100 MPa, less than or equal to 75 MPa, or less. In embodiments, the colored glass article made from the glass composition may have a maximum central tension after ion-exchange strengthening greater than or equal to 40 MPa and less than or equal to 250 MPa, greater than or equal to 50 MPa and less than or equal to 225 MPa, greater than or equal to 60 MPa and less than or equal to 200 MPa, greater than or equal to 70 MPa and less than or equal to 175 MPa, greater than or equal to 80 MPa and less than or equal to 150 MPa, greater than or equal to 90 MPa and less than or equal to 125 MPa, greater than or equal to 100 MPa and less than or equal to 250 MPa, or any and all sub-ranges formed from any of these endpoints. As utilized herein, central tension refers to a maximum central tension value unless otherwise indicated.

In embodiments, a ratio of compressive stress to central tension of the colored glass article made from the glass composition, after ion-exchange strengthening, may be from 2:1 to 10:1, from 2:1 to 8:1, from 4:1 to 10:1, from 4:1 to 8:1, from 6:1 to 10:1, or even from 6:1 to 8:1, or any and all sub-ranges formed from any of these endpoints.

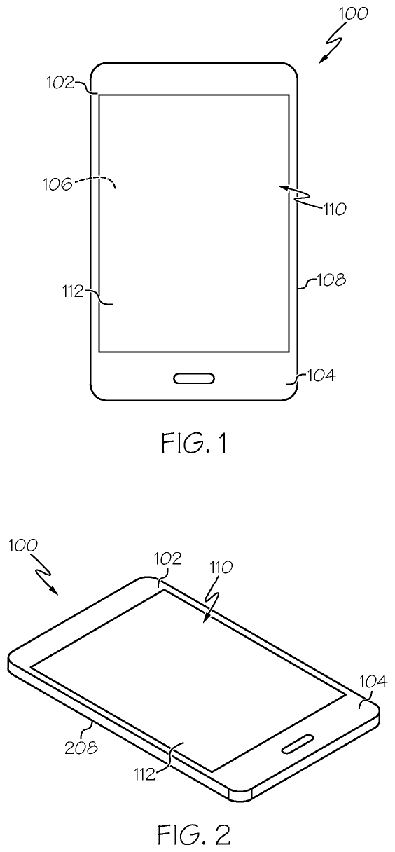

The colored glass articles described herein may be used for a variety of applications including, for example, back cover applications in consumer or commercial electronic devices such as smartphones, tablet computers, personal computers, ultrabooks, televisions, and cameras. An exemplary article incorporating any of the colored glass articles disclosed herein is shown in FIGS. 1 and 2. Specifically, FIGS. 1 and 2 show a consumer electronic device 100 including a housing 102 having front 104, back 106, and side surfaces 108; electrical components (not shown) that are at least partially inside or entirely within the housing and including at least a controller, a memory, and a display 110 at or adjacent to the front surface of the housing; and a cover substrate 112 at or over the front surface of the housing such that it is over the display. In embodiments, at least a portion of housing 102, such as the back 106, may include any of the colored glass articles disclosed herein.

### EXAMPLES

In order that various embodiments be more readily understood, reference is made to the following examples, which illustrate various embodiments of the glass compositions and glass-based articles described herein.

Examples with glass compositions as shown in Table I were produced. The concentrations in Table I are reported in mol % unless otherwise indicated. The liquidus temperature was measured as described herein, and observations on the inclusion of gold particles and color of the examples were recorded.

Gold particles were not considered a phase in Table I below. As such, the liquidus temperature provided in Table I does not take into consideration gold particles. If gold particles were considered a phase, the liquidus temperature may change. For example, if the gold particles were considered a phase, Example BB would have a liquidus temperature of 1265° C.

TABLE I

| Example | AA | BB | CC | DD |
|---|---|---|---|---|
| SiO₂ | 70.08 | 70.10 | 70.07 | 71.98 |
| Al₂O₃ | 14.44 | 14.42 | 14.44 | 14.44 |
| B₂O₃ | 0.00 | 0.00 | 0.00 | 0.00 |
| Li₂O | 8.02 | 8.05 | 8.05 | 7.10 |
| Na₂O | 6.15 | 6.14 | 6.13 | 5.18 |
| K₂O | 0.20 | 0.20 | 0.19 | 0.20 |
| MgO | 0.02 | 0.02 | 0.03 | 0.02 |
| CaO | 1.00 | 1.00 | 1.00 | 1.00 |
| ZnO | 0.00 | 0.00 | 0.00 | 0.00 |
| Fe₂O₃ | 0.071 | 0.072 | 0.072 | 0.074 |
| MnO₂ | 0.000 | 0.000 | 0.000 | 0.000 |
| SnO₂ | 0.06 | 0.05 | 0.05 | 0.06 |
| Bi₂O₃ | 0.000 | 0.000 | 0.000 | 0.000 |
| Au (ppm) | 29 | 56 | 82 | 30 |
| Ag (ppm) | 0 | 0 | 0 | 0 |
| Pt (ppm) | 0.0 | 0.0 | 0.0 | 0.0 |
| R₂O | 14.4 | 14.4 | 14.4 | 12.5 |
| R′O | 1.0 | 1.0 | 1.0 | 1.0 |
| R₂O—Al₂O₃ | −0.1 | 0.0 | −0.1 | −2.0 |
| Liduidus Temp. | 1200 | 1195 | 1185 | 1190 |
| (° C.) | | | | |
| Phase1 | Spodumene | Spodumene | Spodumene | Spodumene |
| Phase2 | | | | |
| Comments | No gold | Gold particles up | Gold particles up | No gold particles |
| | particles. | to 1265° C. liquidus | to 1255° C. liquidus | present. liquidus |
| | Coloration below | Coloration below | Coloration below | Coloration below |
| | liquidus. | | | |

| Example | EE | FF | GG | HH |
|---|---|---|---|---|
| SiO₂ | 72.01 | 71.98 | 72.07 | 72.08 |
| Al₂O₃ | 14.42 | 14.43 | 12.45 | 12.46 |
| B₂O₃ | 0.00 | 0.00 | 0.00 | 0.00 |
| Li₂O | 7.12 | 7.12 | 8.06 | 8.03 |
| Na₂O | 5.16 | 5.17 | 6.13 | 6.14 |
| K₂O | 0.20 | 0.20 | 0.20 | 0.19 |
| MgO | 0.02 | 0.03 | 0.02 | 0.02 |
| CaO | 0.99 | 0.99 | 0.99 | 0.99 |
| ZnO | 0.00 | 0.00 | 0.00 | 0.00 |
| Fe₂O₃ | 0.073 | 0.074 | 0.072 | 0.072 |
| MnO₂ | 0.000 | 0.000 | 0.000 | 0.000 |
| SnO₂ | 0.05 | 0.06 | 0.06 | 0.05 |
| Bi₂O₃ | 0.000 | 0.000 | 0.000 | 0.000 |
| Au (ppm) | 53 | 56 | 33 | 58 |
| Ag (ppm) | 0 | 0 | 0 | 0 |
| Pt (ppm) | 0.0 | 0.0 | 0.0 | 0.0 |
| R₂O | 12.5 | 12.5 | 14.4 | 14.4 |
| R′O | 1.0 | 1.0 | 1.0 | 1.0 |
| R₂O—Al₂O₃ | −1.9 | −1.9 | 1.9 | 1.9 |
| Liduidus Temp. | 1185 | 1205 | 1150 | 1155 |
| (° C.) | | | | |
| Phase1 | Spodumene | Spodumene | Spodumene | Spodumene |
| Phase2 | | | | |
| Comments | No gold particles | No gold particles | Gold particles up | Gold particles up |
| | present. Coloration below | present. Coloration below | to 1235° C. | to 1300° C. |
| | liquidus | liquidus | Coloration below | Coloration up to |
| | | | liquidus | 1215° C. |

| Example | II | C | D | E |
|---|---|---|---|---|
| SiO₂ | 72.08 | 69.86 | 69.71 | 69.62 |
| Al₂O₃ | 12.45 | 14.29 | 14.47 | 14.07 |
| B₂O₃ | 0.00 | 0.00 | 0.00 | 0.00 |
| Li₂O | 8.03 | 7.98 | 7.96 | 7.18 |
| Na₂O | 6.15 | 6.61 | 6.13 | 6.55 |
| K₂O | 0.20 | 0.20 | 0.20 | 0.20 |
| MgO | 0.02 | 0.03 | 0.49 | 0.90 |
| CaO | 0.99 | 0.98 | 1.00 | 0.96 |
| ZnO | 0.00 | 0.00 | 0.00 | 0.47 |
| Fe₂O₃ | 0.072 | 0.047 | 0.046 | 0.046 |
| MnO₂ | 0.000 | 0.000 | 0.000 | 0.000 |
| SnO₂ | 0.05 | 0.05 | 0.06 | 0.05 |
| Bi₂O₃ | 0.000 | 0.000 | 0.000 | 0.000 |
| Au (ppm) | 77 | 22 | 30 | 21 |
| Ag (ppm) | 0 | 0 | 0 | 0 |
| Pt (ppm) | 0.0 | 0.0 | 0.0 | 0.0 |
| R₂O | 14.4 | 14.8 | 14.3 | 13.9 |
| R′O | 1.0 | 1.0 | 1.5 | 2.3 |
| R₂O—Al₂O₃ | 1.9 | 0.5 | −0.2 | −0.1 |
| Liduidus Temp. | 1155 | 1160 | 1160 | 1155 |
| (° C.) | | | | |
| Phase1 | Spodumene | Spodumene | Spodumene | Spodumene |
| Phase2 | | | | |
| Comments | Gold particles up | No gold particles | No gold particles | Gold particles up |
| | to 1255° C. | present. Coloration below | Coloration below | to 1210° C. |
| | Coloration up to | liquidus | present. liquidus | Coloration below |
| | 1235° C. | | | liquidus |

| Example | F | G | H | I |
|---|---|---|---|---|
| SiO₂ | 69.74 | 70.52 | 70.00 | 70.66 |
| Al₂O₃ | 14.30 | 14.04 | 14.46 | 14.34 |
| B₂O₃ | 0.00 | 0.00 | 0.00 | 0.00 |
| Li₂O | 7.20 | 7.25 | 7.20 | 7.22 |
| Na₂O | 6.10 | 5.58 | 5.14 | 4.63 |
| K₂O | 0.20 | 0.20 | 0.20 | 0.19 |
| MgO | 0.94 | 0.92 | 0.98 | 0.95 |
| CaO | 0.99 | 0.97 | 1.00 | 0.99 |
| ZnO | 0.47 | 0.46 | 0.97 | 0.96 |
| Fe₂O₃ | 0.047 | 0.047 | 0.047 | 0.047 |
| MnO₂ | 0.000 | 0.000 | 0.000 | 0.000 |
| SnO₂ | 0.05 | 0.05 | 0.06 | 0.05 |
| Bi₂O₃ | 0.000 | 0.000 | 0.000 | 0.000 |
| Au (ppm) | 23 | 24 | 30 | 24 |
| Ag (ppm) | 0 | 0 | 0 | 0 |
| Pt (ppm) | 0.0 | 0.0 | 0.0 | 0.0 |
| R₂O | 13.5 | 13.0 | 12.5 | 12.0 |
| R′O | 2.4 | 2.4 | 2.9 | 2.9 |
| R₂O—Al₂O₃ | −0.8 | −1.0 | −1.9 | −2.3 |
| Liduidus Temp. | 1165 | 1185 | 1175 | 1220 |
| (° C.) | | | | |
| Phase1 | Spodumene | Spodumene | Spodumene | Spinel |
| Phase2 | | | | |
| Comments | Gold particles up | No gold particles | No gold particles | No gold particles |
| | to 1190° C. liquidus | present. liquidus | present. liquidus | present. |
| | Coloration below | Coloration below | Coloration below | Coloration below |
| | | | | liquidus |

| Example | J | K | L | M |
|---|---|---|---|---|
| SiO₂ | 70.61 | 72.02 | 70.14 | 70.62 |
| Al₂O₃ | 14.06 | 14.41 | 14.45 | 14.46 |
| B₂O₃ | 0.00 | 0.00 | 0.00 | 0.00 |
| Li₂O | 8.07 | 7.17 | 7.04 | 7.05 |
| Na₂O | 6.04 | 5.13 | 5.14 | 5.15 |
| K₂O | 0.20 | 0.19 | 0.19 | 0.20 |
| MgO | 0.02 | 0.02 | 1.01 | 1.01 |
| CaO | 0.94 | 0.99 | 1.00 | 0.50 |
| ZnO | 0.00 | 0.00 | 0.97 | 0.97 |
| Fe₂O₃ | 0.044 | 0.046 | 0.040 | 0.040 |
| MnO₂ | 0.000 | 0.000 | 0.015 | 0.016 |
| SnO₂ | 0.03 | 0.06 | 0.06 | 0.06 |
| Bi₂O₃ | 0.000 | 0.000 | 0.000 | 0.000 |
| Au (ppm) | 14 | 28 | 32 | 30 |
| Ag (ppm) | 0 | 0 | 0 | 0 |
| Pt (ppm) | 0.0 | 0.0 | 0.7 | 0.8 |
| R₂O | 14.3 | 12.5 | 12.4 | 12.4 |
| R′O | 1.0 | 1.0 | 3.0 | 2.5 |
| R₂O—Al₂O₃ | 0.2 | −1.9 | −2.1 | −2.1 |
| Liduidus Temp. | 1180 | 1195 | 1180 | 1220 |
| (° C.) | | | | |
| Phase1 | Spodumene | Spodumene | Spodumene | Spinel |
| Phase2 | | | | Spodumene |
| Comments | No gold particles | No gold particles | No Au particles | No Au particles |
| | present. | present. | or coloration. | or coloration. |
| | Coloration below | Coloration below | Spinel/Cassiterite/ | Spodumene up |
| | liquidus | liquidus | Contam up to | to 1185° C. |
| | | | 1230° C. | |

| Example | N | O | P | Q |
|---|---|---|---|---|
| SiO₂ | 68.15 | 70.07 | 70.12 | 70.24 |
| Al₂O₃ | 15.44 | 14.48 | 14.46 | 14.44 |
| B₂O₃ | 0.00 | 0.00 | 0.00 | 0.00 |
| Li₂O | 7.54 | 7.05 | 7.06 | 7.05 |
| Na₂O | 5.13 | 5.15 | 5.14 | 5.13 |
| K₂O | 0.19 | 0.20 | 0.20 | 0.20 |
| MgO | 1.52 | 1.27 | 1.01 | 0.50 |
| CaO | 1.00 | 1.24 | 0.99 | 0.50 |
| ZnO | 0.97 | 0.47 | 0.96 | 1.92 |
| Fe₂O₃ | 0.040 | 0.064 | 0.040 | 0.017 |
| MnO₂ | 0.018 | 0.017 | 0.016 | 0.015 |
| SnO₂ | 0.06 | 0.06 | 0.06 | 0.06 |
| Bi₂O₃ | 0.000 | 0.000 | 0.000 | 0.000 |
| Au (ppm) | 27 | 17 | 23 | 20 |
| Ag (ppm) | 0 | 0 | 0 | 0 |
| Pt (ppm) | 0.6 | 0.5 | 0.5 | 0.5 |
| R₂O | 12.9 | 12.4 | 12.4 | 12.4 |
| R′O | 3.5 | 3.0 | 3.0 | 2.9 |
| R₂O—Al₂O₃ | −2.6 | −2.1 | −2.1 | −2.1 |
| Liduidus Temp. | 1220 | 1175 | 1220 | 1270 |
| (° C.) | | | | |
| Phase1 | Spinel | Spodumene | Spinel | Spinel |
| Phase2 | Spodumene | | Spodumene | Spodumene |
| Comments | No Au particles | No Au particles | No Au particles | No Au particles |
| | or coloration. | or coloration. | or coloration. | or coloration. |
| | Spodumene up | | Spodumene up | Spodumene up |
| | to 1165° C. | | to 1165° C. | to 1190° C. |
| Example | R | S | TT | T |
| SiO₂ | 70.12 | 70.16 | 70.03 | 69.76 |
| Al₂O₃ | 14.44 | 14.42 | 14.48 | 14.46 |
| B₂O₃ | 0.00 | 0.00 | 0.00 | 0.54 |
| Li₂O | 7.07 | 7.07 | 7.08 | 7.02 |
| Na₂O | 5.15 | 5.14 | 5.16 | 5.00 |
| K₂O | 0.20 | 0.20 | 0.20 | 0.19 |
| MgO | 1.00 | 1.01 | 1.02 | 1.01 |
| CaO | 1.00 | 1.00 | 1.00 | 1.00 |
| ZnO | 0.96 | 0.96 | 0.96 | 0.97 |
| Fe₂O₃ | 0.040 | 0.040 | 0.060 | 0.040 |
| MnO₂ | 0.015 | 0.017 | 0.301 | 0.018 |
| SnO₂ | 0.06 | 0.05 | 0.06 | 0.06 |
| Bi₂O₃ | 0.000 | 0.000 | 0.000 | 0.000 |
| Au (ppm) | 29 | 25 | 30 | 32 |
| Ag (ppm) | 7 | 20 | 0 | 0 |
| Pt (ppm) | 0.6 | 0.5 | 0.8 | 0.0 |
| R₂O | 12.4 | 12.4 | 12.4 | 12.2 |
| R′O | 3.0 | 3.0 | 3.0 | 3.0 |
| R₂O—Al₂O₃ | −2.0 | −2.0 | −2.0 | −2.2 |
| Liduidus Temp. | 1205 | 1215 | 1235 | 1185 |
| (° C.) | | | | |
| Phase1 | Spinel | Spinel | Spinel | Spinel |
| Phase2 | Spodumene | Spodumene | Spodumene | Spodumene |
| Comments | No Au particles | No Au particles | No Au particles | Coloration and |
| | or coloration. | or coloration. | or coloration. | Au particles |
| | Spodumene up | Spodumene up | Spodumene up | below liquidus |
| | to 1180° C. | to 1180° C. | to 1185° C. | |

| Example | U | V | W |
|---|---|---|---|
| SiO₂ | 67.82 | 65.45 | 70.20 |
| Al₂O₃ | 14.47 | 14.49 | 14.49 |
| B₂O₃ | 2.47 | 4.90 | 0.00 |
| Li₂O | 7.01 | 6.97 | 7.04 |
| Na₂O | 5.00 | 4.98 | 5.02 |
| K₂O | 0.19 | 0.19 | 0.20 |
| MgO | 1.01 | 1.02 | 1.01 |
| CaO | 1.00 | 1.00 | 0.99 |
| ZnO | 0.96 | 0.95 | 0.98 |
| Fe₂O₃ | 0.040 | 0.040 | 0.064 |
| MnO₂ | 0.016 | 0.016 | 0.017 |
| SnO₂ | 0.05 | 0.05 | 0.05 |
| Bi₂O₃ | 0.000 | 0.000 | 0.000 |
| Au (ppm) | 17 | 3 | 5 |
| Ag (ppm) | 0 | 0 | 690 |
| Pt (ppm) | 0.0 | 0.0 | 0.0 |
| R₂O | 12.2 | 12.1 | 12.3 |
| R′O | 3.0 | 3.0 | 3.0 |
| R₂O—Al₂O₃ | −2.3 | −2.4 | −2.2 |
| Liduidus Temp. | 1180 | 1140 | 1210 |
| (° C.) | | | |
| Phase1 | Spinel | Spinel | Spinel |
| Phase2 | | | Spodumene |
| Comments | Coloration and | Coloration and | Coloration and |
| | Au particles | Au particles | Au particles |
| | below liquidus | below liquidus | below liquidus |

| Example | X | A |
|---|---|---|
| SiO₂ | 70.22 | 70.19 |
| Al₂O₃ | 14.48 | 14.47 |
| B₂O₃ | 0.00 | 0.00 |
| Li₂O | 7.05 | 7.07 |
| Na₂O | 5.00 | 5.01 |
| K₂O | 0.20 | 0.20 |
| MgO | 1.01 | 1.26 |
| CaO | 1.00 | 1.24 |
| ZnO | 0.97 | 0.48 |
| Fe₂O₃ | 0.064 | 0.064 |
| MnO₂ | 0.017 | 0.017 |
| SnO₂ | 0.05 | 0.05 |
| Bi₂O₃ | 0.000 | 0.000 |
| Au (ppm) | 5 | 16 |
| Ag (ppm) | 1300 | 1417 |
| Pt (ppm) | 0.0 | 0.0 |
| R₂O | 12.2 | 12.3 |
| R′O | 3.0 | 3.0 |
| R₂O—Al₂O₃ | −2.2 | −2.2 |
| Liduidus Temp. | 1230 | 1195 |
| (° C.) | | |
| Phase1 | Spinel | Spodumene |
| Phase2 | | |
| Comments | Coloration and | Coloration and |
| | Au particles | Au particles |
| | below liquidus | below liquidus |

As described herein, it may be desirable to have relatively low liquidus temperatures to avoid increased devitrification of the glass (e.g., formation of Au particle defects) during the fusion forming process. However, the amount of gold included in the glass composition may lead to the formation of Au particle defects, regardless of the liquidus temperature of the glass composition. For example, Examples AA and BB included similar concentration of Li₂O and Na₂O and the same concentration of MgO, resulting in similar liquidus temperatures of 1200° C. and 1195° C., respectively. Example AA, including 29 ppm Au, did not include gold particles, whereas Example BB, including 56 ppm, included gold particles up to 1265 TC. Formation of Au particle defects may also be related to raw materials, melting conditions, and forming processes, according to best practices known in the industry.

Examples were subjected to various heat treatments and the color was measured as described herein, with the results reported in Table II.

TABLE II

| | | | | | Thickness |
|---|---|---|---|---|---|
| Example | Heat Treatment | L* | a* | b* | (mm) |
| X | 650 C./2 hr | 90.64 | 8.69 | 1.37 | 1.358 |
| X | 670 C./2 hr | 87.60 | 11.31 | 1.24 | 1.352 |
| X | 690 C./2 hr | 83.99 | 8.99 | −5.80 | 1.361 |
| X | 710 C./2 hr | 83.50 | 3.91 | −5.77 | 1.343 |
| X | 730 C./2 hr | 79.69 | 6.64 | −6.98 | 1.338 |
| X | 750 C./2 hr | 78.19 | 10.91 | −5.53 | 1.327 |
| X | 770 C./2 hr | 79.48 | 14.62 | 0.59 | 1.327 |
| X | 790 C./2 hr | 80.25 | 15.90 | 2.40 | 1.312 |
| X | 590 C./48 hr | 90.55 | 8.90 | 3.84 | 1.324 |
| X | 610 C./8 hr | 94.05 | 2.91 | 0.80 | 1.326 |
| X | 630 C./8 hr | 91.01 | 8.14 | 5.28 | 1.344 |
| X | 650 C./8 hr | 89.05 | 10.26 | 11.88 | 1.332 |
| W | 650 C./2 hr | 94.81 | 1.48 | 0.26 | 1.28 |
| W | 670 C./2 hr | 86.87 | 9.42 | −5.12 | 1.28 |
| W | 690 C./2 hr | 90.11 | −0.49 | −4.06 | 1.28 |
| W | 710 C./2 hr | 85.67 | −0.10 | −5.69 | 1.28 |
| W | 730 C./2 hr | 86.84 | 0.57 | −4.71 | 1.28 |
| W | 750 C./2 hr | 91.73 | −0.44 | −1.21 | 1.28 |
| W | 770 C./2 hr | 88.18 | −0.55 | −4.73 | 1.31 |
| W | 790 C./2 hr | 83.93 | 1.74 | −8.10 | 1.35 |
| W | 590 C./48 hr | 91.95 | 5.66 | −0.04 | 1.33 |
| W | 610 C./8 hr | 96.05 | −0.03 | 0.64 | 1.30 |
| W | 630 C./8 hr | 88.87 | 10.70 | −0.70 | 1.28 |
| W | 650 C./8 hr | 88.82 | 10.48 | 2.53 | 1.30 |

| | | | | | Thickness |
|---|---|---|---|---|---|
| Example | Heat Treatment | L* | a* | b* | (mm) |
| A | 650 C/2 hr | 91.04 | 8.16 | 2.13 | 1.29 |
| A | 670 C/2 hr | 87.84 | 12.46 | 13.18 | 1.30 |
| A | 690 C/2 hr | 80.37 | 18.91 | 3.04 | 1.30 |
| A | 710 C/2 hr | 69.99 | 20.23 | −2.11 | 1.31 |
| A | 730 C/2 hr | 75.16 | 15.87 | 5.28 | 1.31 |
| A | 750 C/2 hr | 80.91 | 15.75 | 32.54 | 1.31 |
| A | 770 C/2 hr | 85.09 | 8.42 | 54.86 | 1.26 |
| A | 790 C/2 hr | 85.41 | 9.57 | 39.81 | 1.27 |
| A | 590 C/48 hr | 89.49 | 10.50 | 8.66 | 1.27 |
| A | 610 C/8 hr | 90.60 | 8.47 | 1.25 | 1.26 |
| A | 630 C/8 hr | 88.85 | 11.17 | 12.92 | 1.28 |
| A | 650 C/8 hr | 89.18 | 8.88 | 21.73 | 1.29 |
| O | 630 C/2 hr | 95.84 | 0.09 | 0.44 | 1.264 |
| O | 650 C/2 hr | 84.03 | 11.71 | −7.04 | 1.274 |
| O | 670 C/2 hr | 83.07 | 7.23 | −9.43 | 1.292 |
| O | 690 C/2 hr | 82.51 | 4.57 | −11.03 | 1.294 |
| O | 710 C/2 hr | 79.60 | 0.67 | −13.70 | 1.26 |
| O | 730 C/2 hr | 80.15 | 0.78 | −12.52 | 1.257 |
| O | 750 C/2 hr | 81.80 | 2.06 | −10.66 | 1.232 |
| O | 770 C/2 hr | 83.69 | 1.65 | −9.00 | 1.251 |
| O | 790 C/2 hr | 81.99 | 2.97 | −10.20 | 1.291 |
| O | 590 C/48 hr | 84.58 | 13.89 | −4.35 | 1.275 |
| O | 630 C/8 hr | 85.00 | 13.39 | −3.31 | 1.335 |
| O | 640 C/8 hr | 85.18 | 12.06 | −4.31 | 1.324 |
| O | 650 C/8 hr | 81.94 | 13.99 | −7.50 | 1.28 |
| O | 710 C/8 hr | 82.46 | 2.90 | −10.28 | 1.256 |

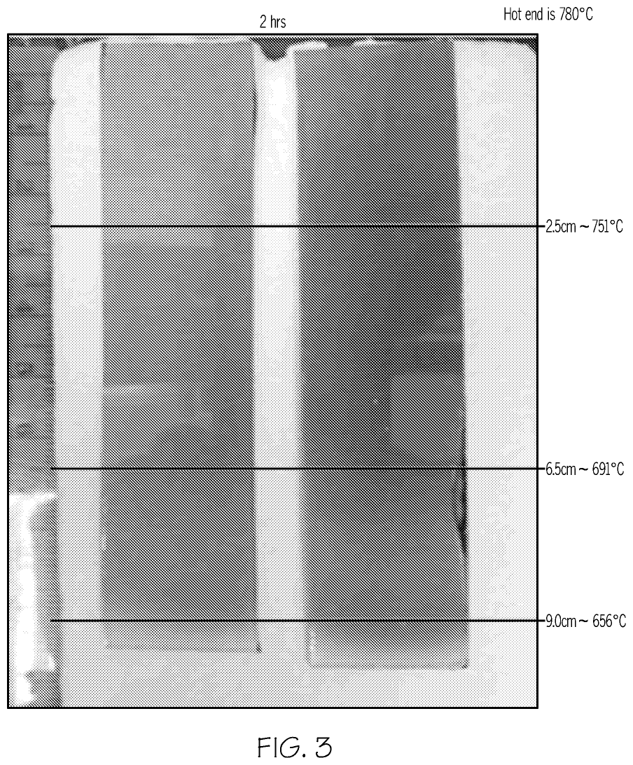

The composition of Example H was fusion formed under the following conditions: melt held at 1650° C., a thermal gradient was applied across the downcomer to the slot where the glass flowed into the isopipe with the glass being 1450° C. at the slot, and the glass was at a temperature of 1210° C. at the root. The produced glass sheets did not include Au defects but did include blisters and Pt. Strips of the produced glass sheets were then heated in a gradient furnace for 2 hours to observe the color produced as a function of heat treatment temperature, the temperature gradient ranged from 640° C. to 780° C. The resulting colored glass strips are shown in FIG. 3.

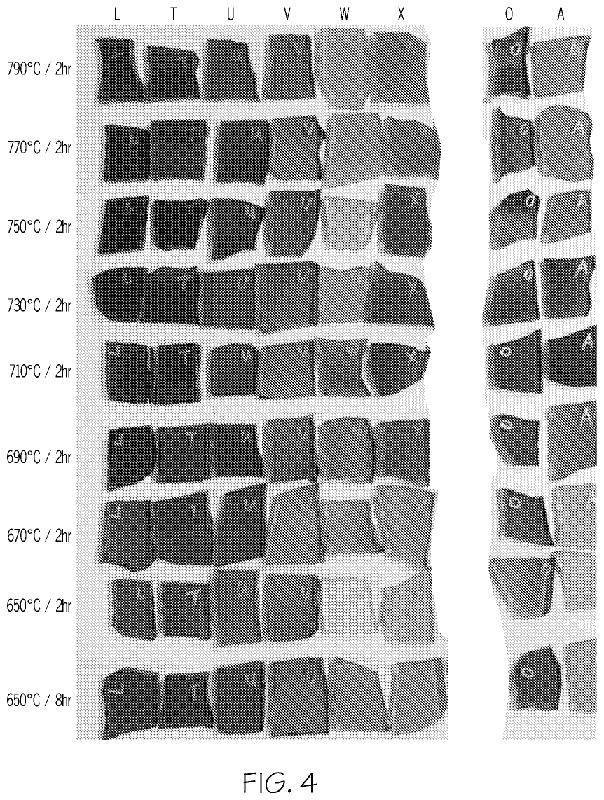

FIG. 4 shows the color produced for various exemplary compositions for different heat treatments.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1-59. (canceled)

60. A glass composition, comprising:
greater than or equal to 60 mol % to less than or equal to 75 mol % SiO₂;
greater than or equal to 10 mol % to less than or equal to 20 mol % Al₂O₃;
greater than or equal to 5 mol % to less than or equal to 20 mol % Li₂O;
greater than or equal to 2 mol % to less than or equal to 15 mol % Na₂O;
greater than 0 mol % to less than or equal to 1 mol % K₂O;
greater than 0 mol % to less than or equal to 8 mol % MgO; and
greater than or equal to 0.0001 mol % to less than or equal to 0.01 mol % Au.

61. The glass composition of claim 60, wherein Li₂O+MgO is greater than or equal to 5 mol % to less than or equal to 20 mol %.

62. The glass composition of claim 60, comprising greater than or equal to 0.0002 mol % to less than or equal to 0.009 mol % Au.

63. The glass composition of claim 60, comprising greater than or equal to 62 mol % to less than or equal to 73 mol % SiO₂.

64. The glass composition of claim 60, comprising greater than or equal to 11 mol % to less than or equal to 19 mol % Al₂O₃.

65. The glass composition of claim 60, comprising greater than or equal to 0 mol % to less than or equal to 10 mol % B₂O₃.

66. The glass composition of claim 60, comprising greater than or equal to 7 mol % to less than or equal to 18 mol % Li₂O.

67. The glass composition of claim 60, comprising greater than or equal to 3 mol % to less than or equal to 12 mol % Na₂O.

68. The glass composition of claim 60, comprising greater than or equal to 0.1 mol % to less than or equal to 1 mol % K₂O.

69. The glass composition of claim 60, comprising greater than or equal to 0.1 mol % to less than or equal to 7 mol % MgO.

70. The glass composition of claim 60, comprising greater than or equal to 0 mol % to less than or equal to 8 mol % CaO.

71. The glass composition of claim 60, comprising greater than or equal to 0 mol % to less than or equal to 8 mol % ZnO.

72. The glass composition of claim 60, comprising greater than or equal to 0 mol % to less than or equal to 0.1 mol % Fe₂O₃.

73. The glass composition of claim 60, comprising greater than or equal to 0 mol % to less than or equal to 0.5 mol % MnO₂.

74. (canceled)

75. The glass composition of claim 60, comprising greater than or equal to 0 mol % to less than or equal to 0.5 mol % Bi₂O₃.

76. The glass composition of claim 60, comprising greater than or equal to 0 mol % to less than or equal to 0.2 mol % Ag.

77. The glass composition of claim 60, comprising greater than or equal to 0 mol % to less than or equal to 0.001 mol % Pt.

78. The glass composition of claim 60, comprising greater than or equal to 10 mol % to less than or equal to 25 mol % R₂O, wherein R₂O=Li₂O+Na₂O+K₂O+Rb₂O+Cs₂O.

79. The glass composition of claim 60, comprising greater than or equal to 0 mol % to less than or equal to 8 mol % R′O, wherein R′O=MgO+BaO+CaO+SrO+BeO+ZnO.

80. The glass composition of claim 60, wherein R₂O—Al₂O₃ is greater than or equal to −4 mol % to less than or equal to 4 mol %, wherein R₂O=Li₂O+Na₂O+K₂O+Rb₂O+Cs₂O.

81-101. (canceled)
